(19) United States
(12) Patent Application Publication
(10) Pub. No.: US 2011/0019877 A1
(43) Pub. Date: Jan. 27, 2011

(54) Method and Apparatus For Monitoring a Production Line

(76) Inventors: Martin Kasemann, Monheim (DE); Stefan Strathmann, Erkrath (DE); Helmut Herrmann, Hanau (DE); Martin Käsemann, Monheim (DE)

Correspondence Address: THE DIAL CORPORATION, 19001 N. Scottsdale Road, SCOTTSDALE, AZ, 85255, US

(21) Appl. No.: 12/087,832

(22) PCT Filed: Dec. 8, 2006
(86) PCT No.: PCT/EP2006/011821

§ 371 Date: Oct. 6, 2008

(30) Foreign Application Priority Data
Jan. 19, 2006 (DE) 10 2006 002 704.3

(51) Int. Cl. G06K 9/00

(52) U.S. Cl. 382/107

(57) ABSTRACT

A method for monitoring a production line, in which objects are conveyed over conveyance paths between machines, whereby digital images of the production line are created, is characterized by the steps of (a) generating a reference image sequence, such that it images at least one area of a conveyance path to be monitored between machines, (b) determining the speed or acceleration of an object or a quantity derived therefrom for the reference image sequence, (c) generating a test image sequence, which images the same area of a conveyance path between the machines, (d) determining the speed or acceleration of an object or a quantity derived therefrom for the test image sequence, and (e) comparing the speed or acceleration determined for the test image sequence or a quantity derived therefrom with the corresponding quantity determined for the reference image sequence.

### CROSS-REFERENCE TO RELATED APPLICATIONS

This application is a continuation under 35 USC Sections 365(c) and 120 of International Application No. PCT/EP2006/011821, filed 8 Dec. 2006 and published 26 Jul. 2007 as WO 2007/082575, which claims priority from German Application No. 10 2006 002 704.3, filed 19 Jan. 2006, each of which is incorporated herein by reference in its entirety.

### FIELD OF THE INVENTION

The invention relates to a method and a device for monitoring a production line.

In production of liquid or solid consumer goods articles, the latter are usually filled into containers in the course of the production process, to thereby bring them on the market in packaged form. In the filling and packaging operations, a large number of such containers are filled, sealed, labeled and then packaged or collected in further repackagings at the highest possible speed.

The individual steps of filling, sealing and labeling and further packaging are usually performed by several machines in a production line. The containers are therefore conveyed from one machine to the next. Conveyor belts, conveyor screws or similar devices with which the containers or products are conveyed individually from one machine to the next are used for this conveyance.

The solid or liquid products are filled into the containers at the highest possible clock rate. With known production installations, several hundred containers per minute are filled, labeled and packaged and conveyed rapidly between the individual machines accordingly.

For trouble-free operation of such a production installation, trouble-free conveyance of the products or containers is essential. For example, if containers are conveyed to a machine by means of a conveyor belt and if one of the containers is not delivered to the machine in a position from which the machine can then process this container further, then the machine and thus the production line are blocked due to this container.

Typical disturbances in conveyance of containers or products between machines include, for example, placement outside the allowed limits on the conveyor belt or twisting or tilting or upsetting on a conveyor belt. Causes of such disturbances may include, for example, unexpectedly high tolerances in the geometric dimensions of the objects to be conveyed, faulty adjustment of conveyance systems or handling systems or causes that vary over time, e.g., vibrations, fluctuating climate conditions or wear phenomena.

An analysis of the causes of a disturbance occurring in the production line is often performed by trained persons familiar with the production line, attempting to infer the triggering factors based on the damage that has occurred. Such a manual error analysis is time-consuming and personnel-intensive and therefore expensive, and furthermore, the damage that has occurred allows the actual triggering factor to be determined only to a very limited extent.

Various devices and methods which allow automated and continuous monitoring of a production line are known for detection and analysis of disturbances on conveyor belts in production lines.

WO01/50204 describes a method and a system for monitoring a production line, in which sensors on the production line to be monitored detect production data and supply the data to a computer system, which compares the data thus supplied with preset limit values and, when deviations therefrom are found, displays them in a suitable manner on a display screen for the production line monitored. For example, the system detects the quantity of products output by a machine or a conveyor belt and reports this to the computer system. This method and system thus allow rapid and convenient detection of a deviation but without determining the causes for the deviation,

KR 2003053731 describes a device for monitoring a conveyor belt on which objects are conveyed. For monitoring the conveyor belt, it has a current meter device on its electric drive. A deviation in amperage here is interpreted as an indicator of a disturbance.

The methods and systems known from the state of the art for monitoring a production line thus already detect the effects of a disturbance, e.g., a reduction in the product output of a conveyor belt or a change in the operating parameters of a machine. This information is helpful for determining the cause, but it allows an inference as to the triggering factor of the disturbance only to a limited extent.

### SUMMARY OF THE INVENTION

The present invention includes a method and a device with which the causes of a disturbance in a production line can be detected. More particularly, the present invention includes a method for monitoring a production line in which objects are conveyed between machines over conveyance paths is proposed, having at least the following method steps:
1. generating a reference image sequence, in which at least one area of a conveyance path to be monitored is imaged;
2. determining a statistical characteristic variable derived from the movement of an object conveyed between machines;
3. generating a test image sequence, which images the same area of a conveyance path between the machines;
4. determining the statistical characteristic variable derived from the movement of an object for at least one of the objects imaged in the test image sequence;
5. comparing the statistical characteristic variable determined for the test image sequence with the statistical characteristic variable determined for the reference image sequence.

In the first method step, a reference image sequence which images at least one area of a conveyance path to be monitored between the machines of a production line is generated first. This reference image sequence shows trouble-free operation of the part of a production line to be monitored in a period of time of suitable length. The reference image sequence ideally detects not only a period of time in which the production line to be monitored is operated without trouble but also in which the area to be monitored is operated with the most ideal possible parameters, so that this ensures that the system is not operated at the limit of an operating parameter.

To generate the reference image sequence, for example, a digital camera using a CCD or CMOS chip may be used, with which the desired part of a production line is detected in an image-generating manner and by which the individual images of an image sequence are supplied to a connected computer via a connection. As an alternative to a digital camera, an image sequence may first also be generated with a traditional analog camera, whereby the images are digitized in a subsequent method step. An image sequence could also be composed of multiple partial sequences, which detect different areas of a production line at one point in time, to then be processed as a whole. A production line could be detected and monitored completely in this way.

The reference image sequence generated in this way is first stored on the computer and then analyzed in a subsequent method step.

This analysis in a subsequent method step comprises the determination of a statistical characteristic variable derived from the movement of the objects, e.g., the speeds of the objects conveyed between the machines, i.e., the products to be packaged or the packages or the packaged products that are yet to be processed further.

In a preferred embodiment, the statistical characteristic variable derived from the movement of an object is the speed of an object.

Alternatively, the acceleration can be determined and processed as the statistical characteristic variable derived from the movement of an object, such as that which occurs, for example, with the change in direction of a movement of an object. For simplification, however, the speed of an object is assumed below as the statistical characteristic variable derived from the movement of the object.

The statistical characteristic variable, i.e., the speed of a moving object in one direction, for example, is determined according to known algorithms by first determining corresponding pixels in successive images on the basis of their color value or gray value, for example. Since the period of time between the successive images is known, the speed of the object imaged can be determined on the basis of the displacement of pixels. The speeds thereby determined of the objects conveyed are then stored for further use. In this way the speed of a product conveyed is determined for each location along the entire conveyor line imaged in the reference image sequence.

The statistical characteristic variable of an object is advantageously determined for each location along the conveyance path, so that the conveyance path is monitored continuously along its entire length.

It is also advantageous if the statistical characteristic variable is determined for each object that is imaged in the test image sequence and compared with the corresponding characteristic variable of the reference image sequence.

The reference image sequence must detect a sufficiently long period of time of trouble-free operation, so that a sufficiently large data volume is available for the determination of speeds, to be able to calculate averages of the speeds over time.

In a next method step, a test image sequence is generated. To do so, the camera supplies the images generated to a computer, which combines these images into test image sequences of a predetermined length. The test image sequence records the operation of the production line within a period of time that may have a situation which is to be detected subsequently as deviating. The total monitoring time is therefore subdivided into sections. For each time section, a test image sequence is generated and is processed further in the additional steps of a test method.

Since the method compares information from the test image sequence with corresponding information from the reference image sequence in a subsequent method step to determine a deviation in the test image sequence from the ideal state or trouble-free state, the test image sequence must image the same machine and conveyor belts as the reference image sequence.

The image details in generation of reference image sequence and test image sequence as well as the image repeat rates of the camera are advantageously identical.

In another method step by analogy with the determination of speeds in the reference image sequence, the speeds of the objects are determined in the test image sequence on the basis of the test image sequence. For each object conveyed, the speed at the current location of the object is thus determined. To do so, preferably the same algorithm is used as that used to determine the speeds in the reference image sequence.

The speeds determined for the objects in the test image sequence are compared in another process step with the speed values determined for the reference image sequence. If deviations between the speeds are determined in this comparison, this indicates a possible cause of a disturbance. Such a deviation in the speed of an object may be, for example, a congestion of objects in front of a machine, causing the objects to fall from the belt.

The method thus determines by comparison of the speeds of the objects the locations at which the actual speed of an object deviates from the speed which the object had at this location during trouble-free reference operation, namely during generation of the reference image sequence.

This method thus allows continuous automatic monitoring of a production line.

In a preferred embodiment, in the comparison a deviation is rated as a deviation only if the size of the deviation exceeds a preset limit value. A deviation that is detected and is below the preset limit value is thus not rated as a relevant. This achieves the fact that a tolerance range for the speeds is defined so that only the speed deviations which experience has shown to be relevant are rated as relevant and handled accordingly.

Speed deviations are advantageously marked in the tested image sequence, so that each location of a test image sequence at which a deviation in the speed between the objects of the test image sequence and the reference image sequence was determined is marked. The location may be indicated, for example, by giving the X and Y coordinates in the image. Alternatively or additionally, the location of a deviation may also be marked in color on a display screen by saving the location of the deviation with a noticeable color. For example, if the image area in which no deviation was found is saved in green color, then to characterize a speed deviation found, this area may be saved in the red color.

The speed deviation determined may advantageously be displayed by indicating the direction and the amount of the deviation determined and/or by indicating the speed components in X and Y axis directions, whereby the X and Y axes of the generated images serve as the coordinate system for displaying the speed deviations.

A test image sequence for which a relevant speed deviation has been determined is then stored. If several test image sequences with relevant speed deviations are determined in rapid succession, the last test image sequence detected can always be displayed on a display screen. However, older test image sequences may also be displayed, if desired, so that the information for a subsequent error analysis over multiple test image sequences is available. However, test image sequences for which no relevant speed deviations have been detected may be deleted and/or not stored.

This method may advantageously have the method step, whereby the largest cohesive moving image area in this sequence is determined following generation of the reference image sequence, and subsequent method steps are then performed exclusively for this image area. In generation of the reference image sequence and the test image sequence, the camera may typically record not exclusively only those areas in which objects are conveyed from one machine to another. To minimize the data volume to be processed in subsequent methods steps and thus to allow the fastest possible processing of image sequences at a close point in time, following generation of the reference image sequence, the largest cohesive area in which objects are moved is determined. This is the area of the conveyor belt to be monitored. Other areas in which machine parts are moved and people are moving, for example, are not considered further. This results in a reduction in the data volume to be processed, while also making the method insensitive to movements that do not take place in the area to be inspected, i.e., in the area of the conveyor belt.

To determine the image areas and the largest cohesive image area in which objects are moved, the variance of the color value or gray value over time is determined for each pixel of all images of an image sequence by measuring the color value or gray value. Only if this is significantly above the statistical noise level is this rated as movement of objects and the area treated accordingly. Image areas in which the variance of color values or gray values of pixels over time is below the statistical noise level are masked for the following method steps and are disregarded.

The largest cohesive moving image area determined may be marked in the reference image sequences and test image sequences, in particular being saved in color. In display of the image sequences, this allows a rapid and simple check on whether this image area has been determined correctly as the relevant image detail determined.

In another method step, the image areas in which the color values of individual pixels fluctuate greatly over time may advantageously be marked as irrelevant and therefore disregarded in subsequent method steps. In such image areas, it is possible to determine the movement of an object and thus its speed of movement only with a disproportionately high computation complexity and therefore time spent. However, complex algorithms for determining the speed of an object in an area of greatly variable colors are not suitable here, since the monitoring system should process the analysis of the generated test image sequences at the closest possible point in time and therefore rapidly, so that a display or other response to a speed deviation determined may take place as close in time as possible. Such image areas are consequently marked as irrelevant for subsequent method steps in an advantageous manner. Such areas are typically caused by light reflection on the objects conveyed or by moving surfaces of liquids in transparent containers.

To perform the method, a device having at least one camera for generating the images and having a computer connected to the camera is used. The camera may be triggered via the connection to the computer in such a way that generation of images is triggered and controlled by the computer and the images are then transmitted to the computer. All other processing steps are performed on the computer.

The method may be imaged in a computer program which can execute all the method steps of the method, initiate generation of images in the camera and control the image settings. The generated images and/or image sequences as well as the speed deviations determined may be displayed on a display screen. It is possible to intervene manually in the program sequence at any time. For example, the analysis of the reference image sequence, in particular the determination of the largest cohesive moving area, may be checked by a person.

The generation of test image sequences, which is repeated following the analysis of the reference image sequence, and the analysis thereof are then performed automatically.

The computer program may be designed so that the images for the next test image sequence are already being generated and transmitted to the computer during the processing of one test image sequence, so that continuous monitoring over time is possible.

In practice, a portable computer, e.g., a laptop, has proven suitable as the computer in particular in combination with a portable black-and-white CCD camera, which together may be used as a mobile system without time-consuming installation. In particular this mobile system allows monitoring of machines or conveyor belts which could not be monitored previously or for which a permanently installed monitoring system would be too complex and whose economic benefit would thus be doubtful.

### BRIEF DESCRIPTION OF THE DRAWINGS

The inventive method is described in more concrete terms below on the basis of an exemplary embodiment, in which:

FIG. 1 is a schematic diagram of a production line having a monitoring device;

FIG. 2 is a schematic diagram of the largest cohesive moving area; and

FIG. 3 is a graphic diagram of the speed determined and a deviation therefrom.

### DETAILED DESCRIPTION OF THE INVENTION

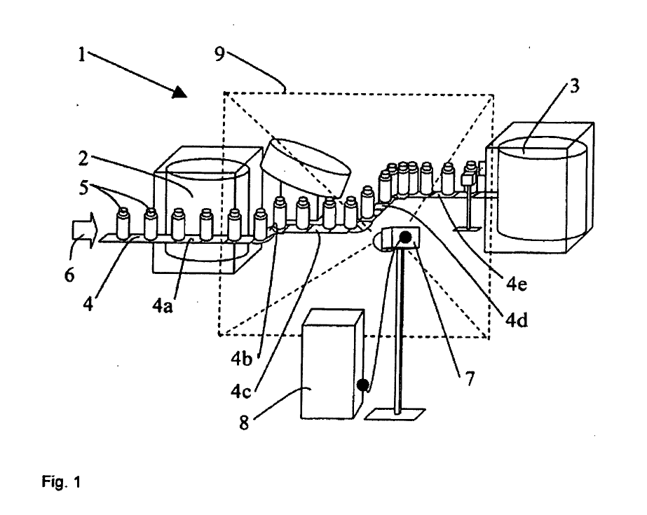

FIG. 1 is a schematic diagram of a production line 1 having the monitoring system. The production line has a first machine 2 and a second machine 3, which in this exemplary embodiment are a bottling machine 2 and a labeling machine 3. The bottling machine 2 fills the bottles 5 with a liquid. A conveyor belt 4 conveys objects 5, transparent bottles 5 here, first toward the bottling machine 2 and then to the labeling machine 3 in the direction indicated by the arrow 6.

The monitoring system has a camera 7 for generating the reference image sequences and test image sequences which is connected to a computer 8. The camera 7 is positioned so that it detects the section of the conveyor belt 4 to be monitored from a position that is elevated in relation to the conveyor belt 4. The image sequences generated thus show a view of the portion of the production line 1 to be monitored and/or the portion of the conveyor belt 4 to be monitored.

In this exemplary embodiment, the camera 7 records the area bordered by the frame 9, shown with a dash-dot line, comprising a portion of the conveyor belt 4, which conveys bottles 5 from the filling machine 2 to the labeling machine 3. The image sequences generated by the camera 7 may thus image the section of the conveyor belt 4 to be monitored between the machines 2, 3.

At the start of the method, the camera 7 generates the images for the reference image sequence, which reflects trouble-free conveyance of the bottles 5, which is as ideal as possible. The reference image sequence usually has a duration of a few seconds up to a few minutes, typically 60 seconds. For this duration, manual verification that the conveyance of the bottles 5 by means of the conveyor belt 4 is taking place in a trouble-free manner with the most ideal parameters possible is ensured.

Camera 7 is set so that the images for the reference image sequence are generated with a sufficiently high image frequency, so that the movement of the bottles 5, which are the objects of interest here, on the conveyor belt 4 that is to be monitored may be tracked definitively on the basis of the image. In practice, it has been found that the image frequency is preferably to be adjusted, so that an object is able to advance a maximum of 4 pixels between two images.

With conventional conveyor belts and a camera distance that ensures a sufficient size of the moving objects, the camera should generate the image sequences with more than 50 images per second.

In addition, it is sufficient if the image sequences are generated in black and white, so that colors are imaged as gray values. Imaging of the area to be monitored in black-and-white images in which the colors are detected as gray values yields a smaller data volume, but at the same time this ensures that the images generated will have a sufficient information content to be able to determine an object and its respective speed.

The images of the reference image sequence are transmitted from the camera 7 to the computer 8, which performs all the further processing of the images.

The computer first determines in the reference image sequence the areas in which any movement takes place. This is first the area in which the bottles 5 are moved by means of the conveyor belt 4. Secondly, moving machine parts or a moving person may be imaged in the image sequences. The image details detected as moving image area may be displayed so they are marked visibly on the screen of the computer 8, so that there is the possibility of monitoring.

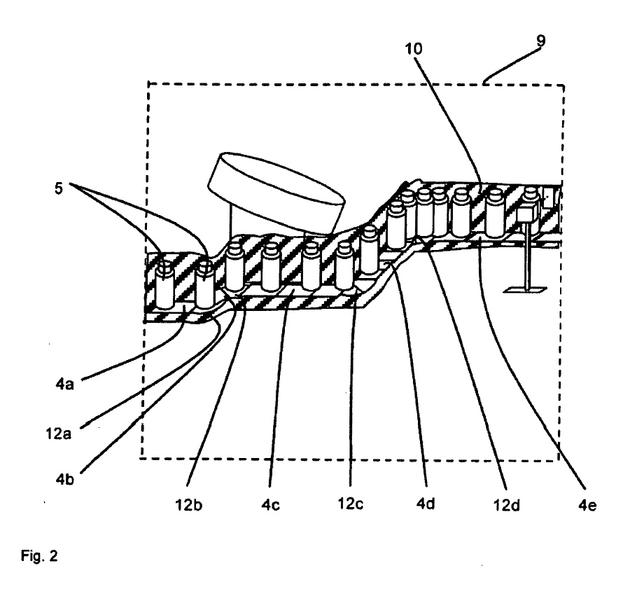

FIG. 2 shows the image detail ordered by the dash-dot frame 9 recorded by the camera 7 from its position.

The computer 8 has determined the largest cohesive moving image area 10 for all images and thus all image sequences generated from this position of the camera 7. This image area 10 is marked visibly on the screen of the computer 8, e.g., by colored storage of the area. The largest cohesive moving image area 10 is marked by hatching in FIG. 2.

The marking of this image detail, which computer 8 has determined to be the largest cohesive moving area 10, is valid for all images of this reference image sequence and the test image sequences, so that this area need be determined only once at the beginning of the method on the basis of the reference image sequence.

All the following method steps are performed only for the largest cohesive moving area detected. As a result, the computer 8 must process only a partial detail of the image and consequently only a portion of the image data, so that the data volume to be processed is greatly reduced and further processing may take place at a close point in time.

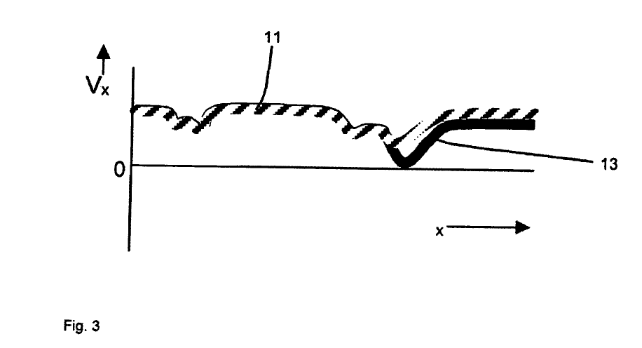

FIG. 3 shows a graphic display of the determined speeds of conveyed bottles 5 in the horizontal image direction and along the conveyance path. The X axis of the coordinate system indicates the location in the X direction along the conveyor belt 4. The value of the speed in the X direction, i.e., the speed component Vx, is given on the Y axis of the graph.

The hatched line 11 indicates the speeds Vx of the bottles 6 determined on the basis of the reference image sequence. The total length of the conveyor belt 4 imaged on the images is subdivided by curves 12a through 12d into the line segments 4a through 4e. The speeds of the bottles 5 in the reference image sequence are the greatest on the first line section 4a and the parallel sections 4c and 4e and are almost equal in size. In curves 12a through 12d, the amount of the speed in X direction drops greatly. The speeds of the bottles 5 are much lower on the line sections 4b and 4d running low in the drawing but are not equal to zero, because the camera detects an oblique view of these line sections.

Like the determination of the speeds in X direction, there is also a determination of speeds in the direction of conveyance perpendicular thereto, running into the plane of the paper in the diagrams and not shown here.

The speeds are averaged over time. As an alternative to averaging of the speeds over time, a spatial averaging is also conceivable, in which the averaging or the determination of a statistical characteristic variable is performed over an image area defined around a pixel to be considered. In another alternative, a space-time averaging could be performed, in which multiple successive images of a sequence are used, and of these an image area around a pixel to be considered is used to determine the statistical characteristic variable.

Instead of such a statistical characteristic variable of the first order, i.e., averaging of the speed value over time, statistical characteristic variables of a higher order, e.g., the standard deviation or variance or statistical characteristic variables of the third order or an even higher order may be used as the reference value for the determination of a deviation from the ideal case. However, for the sake of simplicity, the invention is explained below on the basis of speed deviations.

The speeds thus determined on the basis of the reference image sequence are stored and used as reference values for the test image sequences to be generated subsequently.

After the reference speed values in X and Y directions have each been determined from the reference image sequence, the test image sequences may be subsequently generated and analyzed. To monitor the normal operation of the conveyor belt, therefore test image sequences, which show the conveyor belt during normal operation, are then generated. It should be possible then to detect the disturbances at an early point in time on the basis of test image sequences.

The test image sequences are generated with the same camera settings and from the same position as the reference sequence, so that the test image sequences are comparable to the reference image sequence. A test image sequence has a duration of a few seconds to a few minutes, but the duration of the test image sequence may deviate from the duration of the reference image sequence. The test image sequences follow one another in time continuously, so that the area to be monitored is monitored without interruption during the monitoring.

The speeds of the bottles 5 along the conveyance path are then determined on the basis of the test image sequences. The speeds and/or the speed components are preferably determined using the same algorithm that was used for the analysis of the reference image sequence, so that deviations in speed values due to different determination methods may be ruled out.

The speeds determined for a test image sequence are then compared with those of the reference image sequence to discover deviations.

A speed deviation determined is shown in FIG. 3 as a solid line 13. This indicates that the speed of the bottles 5 is lower in X direction before the curve 12d and on the following conveyor belt section 4e than the reference speed. This means that the bottles 5 are conveyed away from the location in front of the change in direction 12d at a slower rate to the labeling machine 2 than in the reference image sequence. However, the bottles 5 are conveyed at the reference speed up to the location, after which the conveyance speed is lower in the line sections before that, so there is a congestion of bottles in front of the change in direction 12d of the conveyor belt 4. As another result of such a congestion of bottles 5, they may become jammed or fall over, for example, thereby triggering a disturbance in the production line 1.

The speeds per se as well as the deviations in speeds need not be converted to a physical unit. For comparison of the speeds, the absolute value of the speeds is indispensable. Therefore, both the speeds themselves as well as the deviations are given in the pseudounit “pixel between successive images.” This simplified analysis of speeds and deviations greatly simplifies the analysis of image sequences and thus reduces the computation complexity required for analysis.

Such a deviation in speed may occur, for example, by the fact that the bottles rub along a guide rail at a location on the conveyor belt 4 and are thereby decelerated.

Another possible source for a speed deviation may be, for example, a transfer station, which places the objects from a first conveyor belt onto a second conveyor belt. Such a station may be designed essentially as a rotating disk, for example, on which the objects are placed and conveyed a distance further by rotation, to be placed on the second conveyor belt. If the speed of rotation of the disk deviates from the ideal value, then the bottles may be placed on an edge of the second conveyor belt, for example. This position of a bottle 5 on the conveyor belt 4 deviating from the ideal state may cause contact with a guide rail, for example, which could decelerate the bottle or not fit with the position of the bottle 5 expected by a further processing machine, so that this would cause disturbances. The nonideal position of the bottle on the second conveyor belt may thus be a result of a speed deviation on the one hand while also being the triggering factor for (another) speed deviation.

The comparison of the speeds of the bottles 5 from the test image sequences with those from the reference image sequence over the observed conveyor line thus allows an exact determination of all locations at which the speeds deviate from one another. It is possible in this way in particular to determine the location at which the speed of an object deviates from the reference speed for the first time and at which the chain of successive deviations and disturbances thus begins.

Test image sequences, which have a deviation in speeds from the reference speeds, are stored permanently on a data medium, so that they are permanently available. The test image sequences in which no speed deviation was found are deleted or are not stored because they only indicate trouble-free operation and thus do not supply any relevant information. Since a test image sequence lasts a few seconds up to several minutes, the data volume to be stored is thus limited.

Stored reference image sequences may be loaded back into the computer at a later point in time and used as a comparison for additional test image sequences that might be generated at a much later time. The prerequisite for this, however, is that the test image sequences are generated with the camera settings with which the reference image sequence was generated. In this way, a reference image sequence may be used as a reference again after a longer period of time, e.g., a few days, weeks or months, to determine the changes in speed values of a production line 1 between two points in time with a comparatively long interval between them. For a production line 1 running without interruption, for example, it is thus possible to ascertain whether and, if necessary, which changes in speed are detectable when the production line is operated for a long period of time.

This method thus allows continuous monitoring of a production line or a section thereof, whereby the point in time and the location of the first deviation are determined and stored as an image sequence. In addition, in the case of a detected disturbance, other measures may be triggered. For example, the computer may be connected to a control system which controls the production line 1 in such a way that an alarm may be triggered in it or the machines of the production line may be influenced directly.

1. Method for monitoring a production line (1), in which objects (5) are conveyed over conveyance paths (4) between machines (2, 3), comprising the following method steps:
(a) generating a reference image sequence, such that it images at least one area of a conveyance path (4) to be monitored between machines (2, 3);
(b) determining a statistical characteristic variable derived from the movement of an object (5) conveyed between machines (2, 3);
(c) generating a test image sequence, which images the same area of a conveyance path (4) between the machines (2, 3);
(d) determining the statistical characteristic variable derived from the movement of an object (5) for at least one of the objects (5) imaged in the test image sequence;
(e) comparing the statistical characteristic variable determined for the test image sequence with the statistical characteristic variable determined for the reference image sequence.

2. Method according to claim 1, wherein the statistical characteristic variable derived from the movement of an object (5) is the speed of the object.

3. Method according to any one of the preceding claims, wherein the statistical characteristic variable is determined for each location on the conveyance path (4).

4. Method according to any one of the preceding claims, wherein the statistical characteristic variable is determined for each of the objects (5) imaged in the test image sequence.

5. Method according to any one of the preceding claims, wherein a deviation in the statistical characteristic variable is rated as a deviation only when the deviation exceeds a preset limit value.

6. Method according to any one of the preceding claims, wherein each location at which a deviation in the statistical characteristic variable between the objects (5) of the test image sequence and the reference image sequence was determined is marked in the test image sequence.

7. Method according to claim 6, wherein the characteristic variable deviation thus determined is represented in its X-axis component and its Y-axis component.

8. Method according to claim 6, wherein the location of a characteristic variable deviation in the test image sequence is marked in color.

9. Method according to any one of the preceding claims, wherein a test image sequence is stored if a characteristic-variable deviation between the test image sequence and the reference image sequence has been determined.

10. Method according to any one of the preceding claims, wherein the method also comprises the step, in which following generation of the reference image sequence, the largest cohesive moving image area (10) therein is determined and the following method steps are performed exclusively for this image area.

11. Method according to claim 10, wherein the largest cohesive moving image area (10) determined is marked visibly in the reference image sequences and test image sequences.

12. Method according to claim 10 or 11, wherein the image area (10) determined is provided with a colored background in the reference image sequences and test image sequences.

13. Method according to any one of the preceding claims, wherein image areas are determined for the reference image sequence and test image sequence and are disregarded in the other method steps in which the color values of pixels have great fluctuations over time.

14. Method according to any one of the preceding claims, wherein an average is formed for each location in the determination of the speeds of the objects (5) conveyed.

15. Method according to any one of the preceding claims, wherein the reference image sequences and test image sequences are generated from a recording position that is elevated in comparison with the conveyor line (4).

16. Method according to any one of the preceding claims, wherein the reference image sequences and test image sequences are generated by a digital camera (7) and from the same camera position.

17. Method according to claim 16, wherein the camera position and the camera settings are selected so that the objects (5) conveyed have a maximum displacement of 4 pixels between two successive images due to their movement in trouble-free operation.

18. Device for monitoring a production line (1) with a method according to any one of the preceding claims, wherein the device has at least
(a) means (7) for generating image sequences which image the conveyance path (4) to be monitored;
(b) a computer (8) for determining and comparing statistical characteristic variables, which are derived from the movement of the objects (5) by analyzing the image sequences.

19. Device according to claim 17, wherein the means (7) for generating the image sequences is a digital camera, and the computer (8) is a portable computer.

20. Device according to any one of the preceding claim 17 or 18, wherein the device for transmitting control signals is connected to a control unit of the production line (1).
